(19) United States
(12) Patent Application Publication
(10) Pub. No.: US 2010/0253590 A1
(43) Pub. Date: Oct. 7, 2010

(54) PRESENTATION MODULE

(76) Inventors: Mark Hallbauer, Dresden (DE); Holm Hallbauer, Dresden (DE)

Correspondence Address: Mark Hallbauer, Kathe-Kollwitz-Ufer 76, Dresdan, 01309, DE

(21) Appl. No.: 12/664,236

(22) PCT Filed: Apr. 1, 2008
(86) PCT No.: PCT/EP08/02597

§ 371 Date: May 14, 2010

(30) Foreign Application Priority Data
Jun. 14, 2007 (DE) 102007028011.6
Sep. 19, 2007 (EP) 07018430.4
Sep. 19, 2007 (EP) 07018431.2

(51) Int. Cl. G09G 5/00

(52) U.S. Cl. 345/1.3

(57) ABSTRACT

The present invention relates to a presentation module, especially for use as an electronic selling aid for advertisements, for example in print media, or for insurance policies, the presentation module (1) having a first screen (10) for showing a presentation intended for a customer and a control system (21) for controlling the first screen (10) in dependence on commands and/or data input into the presentation module (1). In order to ensure that it is possible, on the one hand, to impart to the client or customer, in as efficient a manner as possible, in a short time, an overview of the advantageousness and usefulness of the offered services or goods for his enterprise and, on the other hand, to draw up during the discussion with the customer a solution that is optimally adapted to the customer and to explain it in very clear manner to the customer during the customer discussion itself, the control system (21) of the presentation module (1) further has a second screen (20) for showing information intended for a salesperson, especially customer-specific data, and for showing data for controlling the course of the presentation shown on the first screen (10); and an inputting interface (22) for inputting commands and/or data in dependence on the information shown on the second screen (20).

The present invention relates to a presentation module, especially for use as an electronic selling aid for advertisements, for example in print media, or for insurance policies, the presentation module having a first screen for showing a presentation intended for a customer and a control system for controlling the first screen in dependence on commands and/or data input into the presentation module.

When making sales proposals for services and goods, especially proposals for advertisements in print media, on the internet or the like, or proposals for insurance policies etc., it is necessary for the service-provider or salesperson to present his proposal to the customer in question in an, as far as possible, optimally adapted form. In a presentation of such a kind, it is frequently desirable not just to convince the (potential) customer about a proposal but also to find a solution that is, as far as possible, optimised for the customer. For this purpose it is usually necessary that the solution is not drawn up in its definitive form until during the discussion with the customer. This efficiently ensures that, in the end, a tailor-made proposal can be submitted to the customer.

However, when drawing up a customer-specific solution during the discussion with the customer, it has to be ensured that, on the one hand, the customer data required by the service-provider or salesperson is available in transparent form to the service-provider and customer and that, on the other hand, a proposal that is specific to the customer is drawn up in a manner that is clear and that can be followed by the customer. It is frequently necessary during such a customer discussion first to convince the customer of the fact that, for example, a service being newly offered does indeed hold promise of economic success.

On the other hand, it has to be considered that, in the customer discussion, the salesperson or service-provider will have only a limited time available in each case in order to impart his concept to the customer. It is accordingly necessary for this concept to be put across to the customer in an, as far as possible, optimum manner in a short time.

In order to be able to specifically adapt a service to a particular customer, customer-specific data such as, for example, the level of sales of the customer, the market share of the customer, the number of employees of the customer etc. is required. This information is usually available, in the form of card-index cards, to the salesperson before the customer discussion. However, it is often not certain, as far as the salesperson is concerned, that this data is up to date. Therefore, at the start of each sales discussion, the data of the customer is usually discussed with the customer. In order for there to be transparency between the salesperson and the customer, it would then be necessary, for example, for the customer data to be presented on a printed-out sheet of paper.

It is furthermore necessary, at the start of the discussion, to briefly inform the customer about the advantages of the service or goods being offered by the salesperson. For this purpose, hand-outs or similar information sheets are customarily used, which are presented and subsequently handed to the customer. Often in a discussion with a customer the salesperson furthermore presents a proposal (already more or less adapted to the customer), in which the service proposed by the salesperson has already been incorporated. Such a proposal is often also prepared by the salesperson in the form of a hand-out and is handed to the customer during the customer discussion. On the basis of such a proposal, the actual customer-matched solution is usually then jointly drawn up during the sales discussion.

Accordingly, several different hand-outs are usually used as selling aids, in which the advantages of the service offered or of the goods offered are presented during a sales discussion. Moreover, a further additional hand-out is frequently used, by means of which a proposal is submitted to the customer, already incorporating the offered service or goods. Furthermore there is often provided a third hand-out, in which the actual customer-specific solution is drawn up together with the customer during the customer discussion. In all, therefore, a large number of hand-outs, information sheets etc. have hitherto been necessary, which the salesperson and the customer have to discuss during such a sales discussion.

The disadvantage of that customary solution is to be seen especially in the fact that, in the course of the sales discussion, the customer or client frequently loses their overview of the usefulness and advantageousness of the offered service or goods. This means, in other words, that the salesperson can no longer effectively present his service or goods. Likewise, an important part is played by the just limited time generally available during a sales discussion. Within this time it is necessary for the salesperson to present the advantages of his goods or service to the customer in as transparent a manner as possible and, at the same time, to prepare a solution that is, as far as possible, optimal for the customer.

In respect of the drawing up, during the customer discussion, of a solution that is best matched to the customer, it should finally be pointed out that this customer-specific solution frequently cannot be drawn up until during the customer discussion because the actual requirements of the customer generally do not become apparent to the salesperson until during the course of the customer discussion.

It is true that, for such customer discussions, laptop computers are also already being used occasionally in order to simplify the drawing up of a customer-specific solution during the customer discussion. However, it is not possible, using laptop computers, to present to the (potential) customer clearly, in a “manner that is pleasant” for the customer, the advantages and scope of the service or goods offered by the salesperson. This is due to the fact that any laptop computer is in the form of a “one-man work station” and therefore is suitable to an only limited extent, if at all, as a presentation aid in a customer discussion. In particular, a laptop computer used as a presentation aid prevents almost all eye contact between the salesperson and the (potential) customer. This results in the fact that, when using a laptop computer as a presentation aid in a customer discussion, the direct contact between the salesperson and the potential customer is lost or cannot even be established in the first place. This set of problems has been known for a long time. For this reason, it has not hitherto been possible for use of a laptop computer as a presentation module to become established practice in customer discussions.

Starting from the above-described requirements for a customer discussion that is, as far as possible, optimal, the present invention is based on the problem of providing a presentation module for use as an electronic selling aid of the kind mentioned at the beginning, by means of which, in a “manner that is pleasant” for the customer, it is possible, on the one hand, in as efficient a manner as possible, to impart to the client or customer, in a short time, an overview of the advantageousness and usefulness of the offered services or goods for his enterprise and, on the other hand, to draw up during the customer discussion, in transparent manner, a solution that is optimally matched to the customer and to explain it to the customer during the customer discussion itself.

The problem is solved, in accordance with the invention, by a presentation module which has a first screen for showing a presentation intended for a customer and a control system for controlling the first screen in dependence on commands and/or data input into the presentation module, wherein the control system of the presentation module further has a second screen for showing information intended for the salesperson, especially customer-specific data, and for showing data for controlling the course of the presentation shown on the first screen and also an inputting interface for inputting commands and/or data in dependence on the information shown on the second screen. Provision is made therein so that the presentation module according to the invention further has a case-like housing having a first and a second housing shell connected in articulated manner to one another, the first screen being integrated in the first housing shell and the second screen together with the inputting interface being integrated in the second housing shell.

The advantages obtainable with the solution according to the invention—especially when used as an electronic selling aid for advertisements in print media etc.—are very clear. On the one hand, the proposed solution provides a presentation system which makes it possible, by virtue of its construction as an electronic system, to dispense with all hand-outs, information sheets etc. On the other hand, the solution according to the invention makes it possible for the customer data updated during a customer discussion to be input directly into the presentation module by way of the inputting interface and for it to be included in the presentation to be shown to the customer during the customer discussion. This updated customer data is accordingly included in the presentation or the course of the presentation, which substantially simplifies the possible subsequent further processing of that data.

In addition, the presentation module proposed herein is accommodated in a preferably case-like housing so that it forms a device which is easy for the salesperson to carry and on which, in addition to the customer-specific sales presentation, there is loaded all data in electronic form or in software. The presentation module especially has a control system having presentation software, this control system preferably being arranged to generate individualised solutions or parts thereof during the customer discussion and to present them, at least in part, to the customer.

In particular, arrangements are made in accordance with the invention for the first screen—which, as the main screen, serves to display the sales presentation to the customer—to be integrated in one of the housing shells of the housing, whilst the second screen together with the inputting interface is inserted in the other housing shell. Because the salesperson usually sits opposite the customer in a customer discussion, it is possible, using the embodiment of the presentation module according to the invention in the form of a case that can be opened out, for the presentation module to be so opened out that the housing shell having the first screen is in front of the customer while the housing shell having the second screen and the inputting interface is in front of the salesperson. This ensures that the sales presentation can be made in a manner that is pleasant for the customer whilst, on the one hand, the customer can optimally view the first screen and, on the other hand, the eye-contact between the customer and the salesperson is not interrupted, for example by a laptop monitor standing up vertically.

The second screen, which is integrated in that housing shell of the housing which faces the salesperson during the sales discussion, serves for showing information intended for the salesperson, especially customer-specific data, and data for controlling the course of the presentation shown on the first screen. Accordingly, the displays shown on the two screens of the presentation module are usually different from one another. Especially as a result of the fact that, on the one hand, the data and information that is relevant for the salesperson is shown on the second screen, whereas, on the other hand, the presentation intended for the customer, that is to say the data and information that is relevant for the customer, is shown on the first (main) screen, it is possible for the presentation to be made very clear for the (potential) customer.

The displays on the respective screens (first and second screens) are, especially, independent of one another. It is accordingly ensured that, during the sales discussion, the (potential) customer is confronted only with that data and information which is actually intended for him. As a result, especially, overwhelming the customer with data and information that is not relevant to him is avoided.

On the other hand, the presentation module and, in particular, the control system provided in the presentation module should be arranged to control the first and the second screen of the presentation module individually in dependence on a presentation loaded onto the presentation module and/or on commands or data input by way of the inputting interface. This feature makes it possible for a customer-optimised presentation to be playable on the presentation module. For example, it is feasible for the presentation shown on the presentation module to be used as an aid for the selling of advertisements. The latter usually have a very particular geometric shape, which is individually filled with textual content. Relevant data in regard of a target person, that is to say information compiled for a very specific contact person at a potential customers, can then be input by the salesperson by way of the inputting interface of the control system during the sales discussion.

As already indicated, the presentation running on the presentation module according to the invention preferably comprises software which describes a method of generating an individualised customer proposal. In this method, preferably, the customer-relevant data input during the sales discussion by way of the inputting interface is analysed preferably using machine learning. The expression “machine learning” is to be understood herein as especially a self-optimisation process which, on the basis of automatic changes in evaluation criteria etc., produces an improved result on each new run-through. The result is all the better if a greater probability of closing a deal in advertisement selling is achieved.

The advantage of the presentation module according to the invention accordingly lies in the fact that, during the sales discussion, a large amount of individualised customer data can be collected and input into the control system by the salesperson by way of the inputting interface of the presentation module, with evaluation of that individualised customer data being carried out with the aid of the presentation software running on the presentation module so that for different (potential) customers, in real time, that is to say during the sales discussion, an individualised proposal can be produced, incorporated into the presentation that is to be shown to the customer, and shown on the first screen of the presentation module.

It is, especially, feasible that, during assessment of the individualised customer data input by way of the inputting interface of the presentation module, inter alia, a number of prototype classes of so-called customer models are also formed, these customer models representing idealised customer types which have emerged in the classical sales process. The advantage of prototype classes formed using a classifying algorithm lies in the fact that a large number of individualised customers can be mapped onto these prototype customer classes so that although further processing of the information on an individual basis with respect to an individual customer is possible it is still possible to carry out abstract further processing on the basis of the properties of the classes. More abstract further processing in this context means that a whole group of customers can be treated in the same way, for example by means of identical control parameters being input in the next step of the method. This can mean, inter alia, the use of identical customer solutions drawn up during the customer discussion. In the process, the advantages both of purely individualised treatment and also of purely class-based treatment of customer groups are combined with one another.

Preferably, the information content presented to the customer on the first screen consists not of a sequence of standard presentation pages but rather of a tailored sequence of presentation pages which are so arranged that they guide the customer through the sales discussion in structured manner. In the process, information that is directed only to the salesperson is shown on the second screen, preferably in such a way that only he can read it, because it will be seen, for example, by the discussion counterpart (customer) as being “upside-down”, whereas the information that is relevant for the customer will be shown on the first screen of the presentation module so that it can be easily read by the potential customer and—when the customer and salesperson are sitting directly opposite one another in the customer discussion—will be seen by the salesperson as being “upside-down”.

Preferably, the data shown on the second screen of the presentation module and serving for controlling the course of the presentation shown on the first screen comprises a sequence of presentation pages which can be selected by the salesperson during the sales discussion and displayed on the first monitor.

If the customer and the salesperson are sitting opposite one another in the sales discussion it is desirable for the clear view between the salesperson and the customer not to be impeded. For this reason, in the presentation module according to the invention, the two housing shells of the housing are constructed so as to be tiltable relative to one another, preferably up to 220°. Accordingly, the housing can be opened out completely for the customer discussion so that no vertically, or almost vertically, extending display device etc. stands between the customer and the salesperson and accordingly impedes the clear view.

In an especially preferred arrangement of this housing which is capable of being opened out preferably to 220°, provision is made for the control system provided in the presentation module to automatically adjust the orientation of the presentation shown on the first screen in dependence on the degree of opening-out of the housing. Of course, however, other angles of tilt also come into consideration.

By means of this preferred development of the presentation module according to the invention it is accordingly possible, on the one hand, to operate the presentation module in an opened-out mode in which the salesperson sits opposite the (potential) customer and the first screen of the presentation module is oriented towards the customer whilst the information and data displayed on the second screen is oriented towards the salesperson. When the housing is in the completely opened-out state, the presentation shown on the first screen is oriented in a direction opposite to the orientation of the information and data shown on the second screen. On the other hand, when the housing is in a not completely opened-out state, for example in a half opened-out state, preference is given to the presentation shown on the first screen being oriented in the same direction as the information and data shown on the second screen. The presentation module can then be used also for customer discussions in which the customer and salesperson are not sitting opposite one another but rather, for example, are standing next to one another in front of the presentation module.

In order to ensure that the control system of the presentation module “automatically” sets the correct orientation of the presentation to be shown on the first screen, it is feasible, for example, to integrate an appropriate sensor in the hinge connecting the two housing shells, which sensor registers the degree of opening-out of the housing and delivers corresponding signals to the control system in dependence on the degree of opening-out of the housing.

In the completely opened-out state, that is to say when the angle of tilt between the first and the second housing shells is greater than 180°, in order to ensure that the presentation module can be held stable, the presentation module further has, preferably, a support which is in pivotable articulated connection with the second housing shell at or in the vicinity of the articulated connection between the first and the second housing shells. Using this support, the presentation module can then be appropriately raised so that the desired angle of tilt between the first and the second housing shells is held stable. Preferably, it should be possible, in the process, for the support to be brought into the working position in as user-friendly a manner as possible. Of course it is also feasible, additionally or alternatively thereto, for the hinge or articulated connection between the first and the second housing shells of the presentation module to be provided with an appropriate locking mechanism which is arranged to effectively hold the angle of tilt set between the first and the second housing shells.

In the case of the last-mentioned embodiment, in which the presentation module further has a support, preference is given to that support being accommodated, in its pivoted-in state, in a recess provided in the second housing shell. In this preferred embodiment, the outer contour of the second housing shell is accordingly unchanged when the support is completely pivoted in.

In order to ensure that the support is “automatically” pivoted out when the angle of tilt between the first and the second housing shells has exceeded a particular angle, it is feasible in an especially preferred arrangement for a gear mechanism having a first toothed wheel and a second toothed wheel to be provided at the articulated connection, or hinge, between the first and the second housing shells. In this arrangement, the first toothed wheel should so co-operate with the articulated connection, or hinge, between the first and the second housing shells that when the two housing shells are tilted relative to one another the first toothed wheel is concomitantly turned. On the other hand, the second toothed wheel should be connected to the pivot shaft of the support. In this arrangement preference is given to the teeth of the first toothed wheel being arranged to come to mesh with the corresponding teeth of the second toothed wheel only from a predeterminable angle of pivoting set between the first and the second housing shells so that the support begins to be pivoted out, together with the tilting movement of the two housing shells relative to one another, only from the predeterminable angle of pivoting.

In a preferred arrangement of the last-mentioned embodiment, in which the teeth of the first toothed wheel are arranged to come to mesh with the teeth of the second toothed wheel only from the predeterminable angle of pivoting, provision is made for the first toothed wheel and/or the second toothed wheel to have a region without teeth on its periphery. This arrangement is an especially easily produced, and yet effective, solution for ensuring that the support can be rotated out from the second housing shell of the presentation module.

In this case it would be feasible for the support to remain sunk into the recess provided in the second housing shell up to, for example, an angle of tilt of 100° between the two housing shells. When this predeterminable angle of tilt of, for example, 100° is exceeded, the support is rotated out from the recess in the second housing shell by virtue of the special toothed wheel mechanism provided until it has then reached its end position at about 60° and a housing shell opening angle of, for example, 220°. This effect is obtained as a result of the fact that, for example, the toothed wheel driven by the first housing shell (the first toothed wheel) has no teeth in a region from 0° to 110° and only thereafter starts to mesh with the teeth of the toothed wheel associated with the support (the second toothed wheel).

Special preference is given to the special toothed wheel mechanism provided for rotating out the support having a transmission ratio. In this case special preference is given to using a transmission ratio of from 1:1.7 to 1:1.9 in order to ensure that the support can be deployed completely on tilting the two housing shells a relatively small amount in relation to one another. Of course, however, other solutions and also, especially, other transmission ratios also come into consideration in this context.

In principle preference is given to the second screen and the inputting interface of the presentation module being in the form of a structural unit which can be removed from the second housing shell in operation of the presentation module. Preferably, this structural unit is wirelessly connected to the control system of the presentation module, although of course a wired connection would also be possible. The advantage of this particular arrangement is to be seen especially in the fact that the presentation module can be controlled in especially flexible manner, with its being possible, for example, for the salesperson to remotely control the presentation shown on the first screen of the presentation module.

As already explained, preference is given to presentation software which can be influenced by commands and/or data input from the inputting interface running on the presentation module according to the invention. In a preferred arrangement of this embodiment, the control system has, for the purpose, a storage means for storing data for customer-specific presentations and for storing data input by way of the inputting interface, and also a processor for processing data input by way of the inputting interface and for modifying the presentation to be shown on the first screen in dependence on data or commands input by way of the inputting interface.

It is, in principle, advantageous, if the control system of the presentation module according to the invention further has a preferably wireless communications interface, especially a mobile telephone interface, IR interface or Bluetooth interface, in order to make data communications possible with external devices. Of course, however, the communications interface can also be wired, such as, for example, an interface for a PDA device, or an interface for a USB stick. By means of this additional communications interface it is possible to transfer into the control system the presentation to be shown using the presentation module. On the other hand, an interface of such a kind for an external device is also suitable for the purpose of downloading from the presentation module, after the sales discussion, the solution specifically drawn up for the customer in order to be able to further process it or to store it externally.

Having regard to the housing of the presentation module, preference is given to the outer edges of the housing having a rounded-off shape such that that surface of the housing on which the housing lies is defined by the outside of the first or the second housing shell. By this means it is ensured that the presentation module, especially in its closed-together state, is always so put away that the first or second housing shell defines the surface of the presentation module on which the latter lies. Accordingly, as a result of the rounded-off shape of the outer edges of the housing, the presentation module cannot, in the closed-together state, be placed on the lateral surfaces of the housing; this effectively prevents (unintentional) toppling-over of the presentation module and consequent damage to the electronic components present in the presentation module.

In an especially preferred embodiment of the presentation module according to the invention, the second screen, on which there is shown the information intended for the salesperson and also the data for controlling the course of the presentation shown on the first screen, is in the form of a touch screen monitor, with the inputting interface of the presentation module being integrated, in the form of a touch screen field, in this second screen in the form of a touch screen monitor. In this case it would furthermore be feasible for the presentation module to be provided with the functionality of text recognition so that the inputting of information can be carried out with the aid of a touch screen stylus pen by way of the inputting interface. Of course, however, it is also feasible for the first screen serving for showing the presentation intended for the customer to be in the form of a touch screen monitor.

In order to simplify the inputting of data by way of the inputting interface of the presentation module, especially when the data comprises lengthy text fields etc., provision can preferably be made for the inputting interface to additionally have a keyboard connected or connectible to the control system. By means of this development the functionality of the presentation module is correspondingly extended so that—for example, after a customer discussion—it can also be used as a kind of laptop computer.

In order to ensure that, during a sales discussion, the (potential) customer can watch the sales presentation shown on the first screen with optimum image quality independently of the viewing location, preference is given to at least the first screen being in the form of a display screen without a particular preferential viewing direction. This preferred development accordingly prevents colour distortions etc. coming about in dependence on the location of the viewer (customer). In particular, brightness, colour and contrast exhibit changes if a screen without a particular preferential viewing direction is not used as the first screen and the predetermined viewing angle is not maintained. Accordingly, preference is given to using, as the first screen, a screen based on plasma technology or an LC display of class I (according to ISO standard 13406-2). Of course, however, other screens which do not have a particular preferential viewing direction also come into consideration.

In order to allow operational redundancy of the presentation module, the latter should further have an internal power supply, for example in the form of preferably rechargeable batteries and/or a fuel cell. When rechargeable batteries are used as an internal power supply, it is accordingly feasible in a preferred arrangement of the presentation module for the mains unit or charging device required for charging those rechargeable batteries to be provided externally to the presentation module in order, on the one hand, to prevent heat being unnecessarily generated in the housing of case-like construction of the presentation module during the charging period and, on the other hand, to ensure that the overall size of the presentation module is as small as possible. In this context special preference is given to the rechargeable batteries being chargeable by means of, for example, a car battery in order to meet requirements in field sales.

Preferably, the first screen, which serves for showing the sales presentation to the customer, should be of a size matched to the size of the installation space maximally made available by the first housing shell in order, accordingly, to be able to ensure as large an area as possible for the presentation. This requirement is not necessary for the second screen. Rather, the latter screen should be of a size which is dimensioned so that there can be also provided in the second housing shell, in addition to the second screen, a storage compartment for business cards or a notepad. It should then be possible to access this storage compartment when the housing is in the opened state.

Finally, preference is also given to the presentation module further having a protective covering mounted, for example, on the first housing shell, this protective covering being movable in front of the first screen or in front of the rear face of the first housing shell as required. The latter can be necessary especially if the underlying surface on which the presentation module is placed for the purpose of the sales discussion is possibly slightly damaged, so that providing the protective covering between the rear face of the first housing shell and the underlying surface ensures mechanical protection.

Preferred embodiments of the presentation module according to the invention are described hereinbelow with reference to the accompanying drawings, in which:

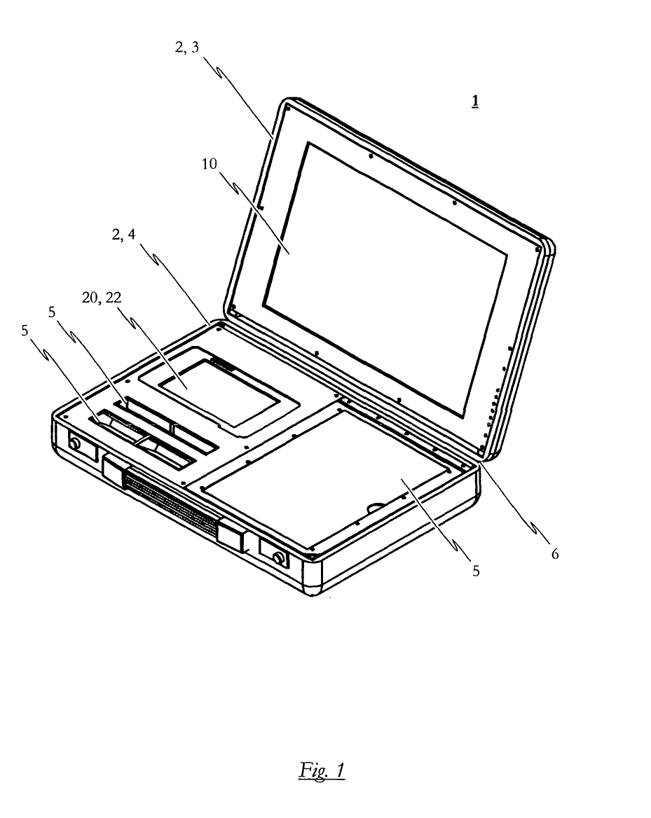

FIG. 1 is a perspective view of a first preferred embodiment of a presentation module, in accordance with the invention, of case-like construction, in the half opened-out state;

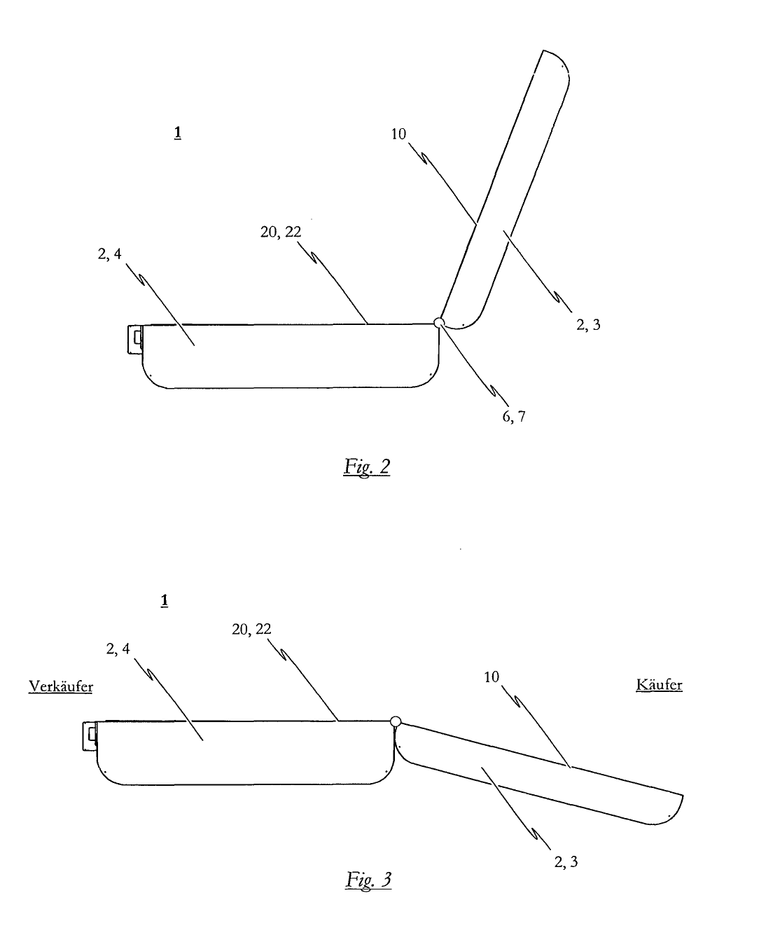

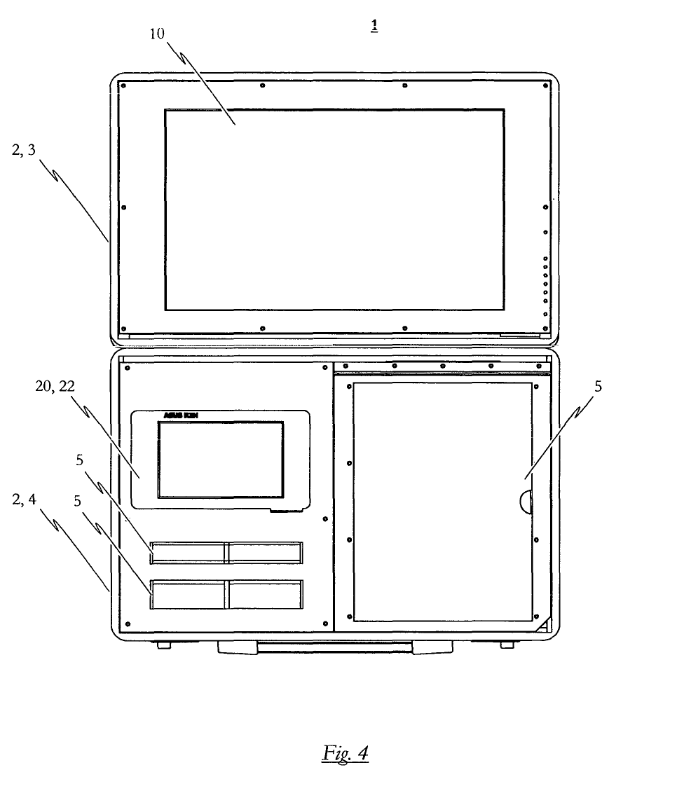

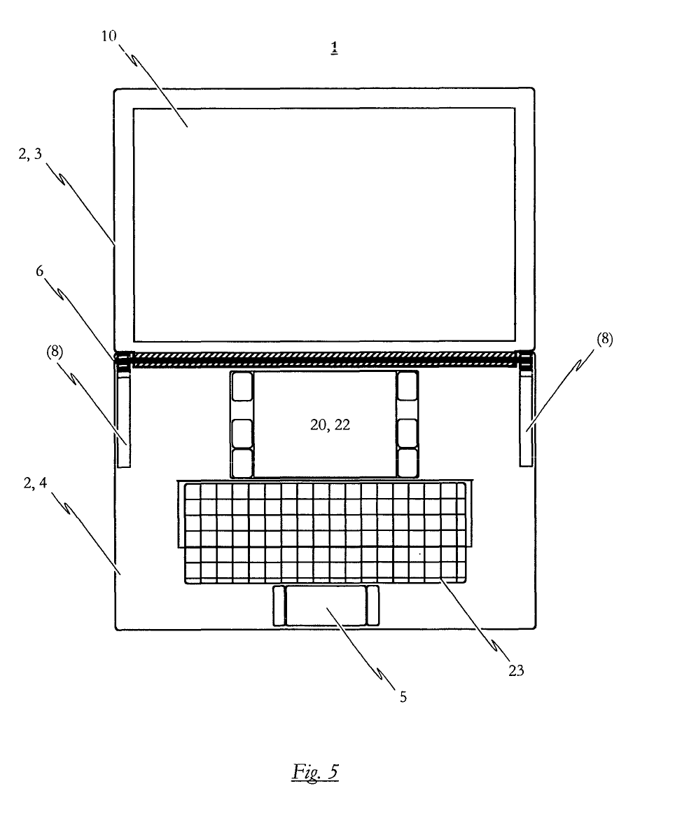

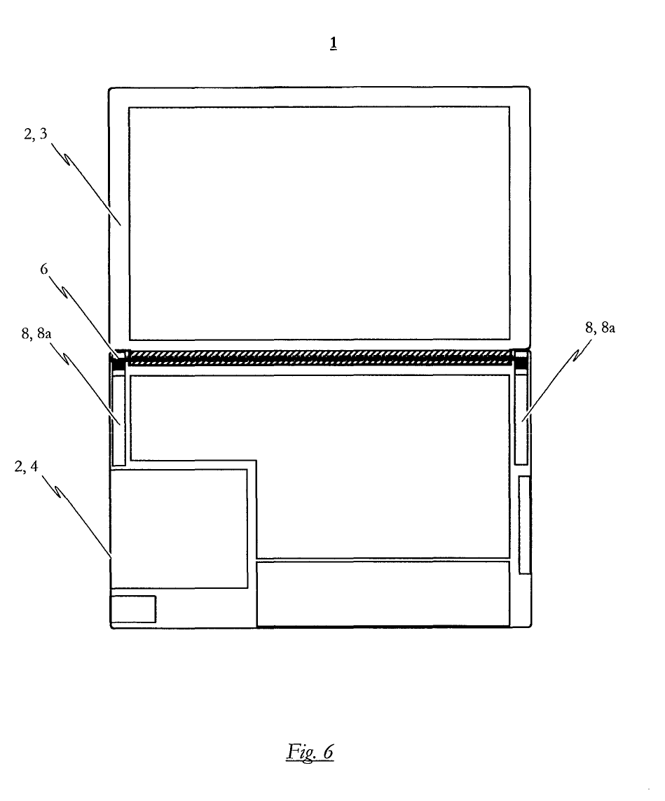

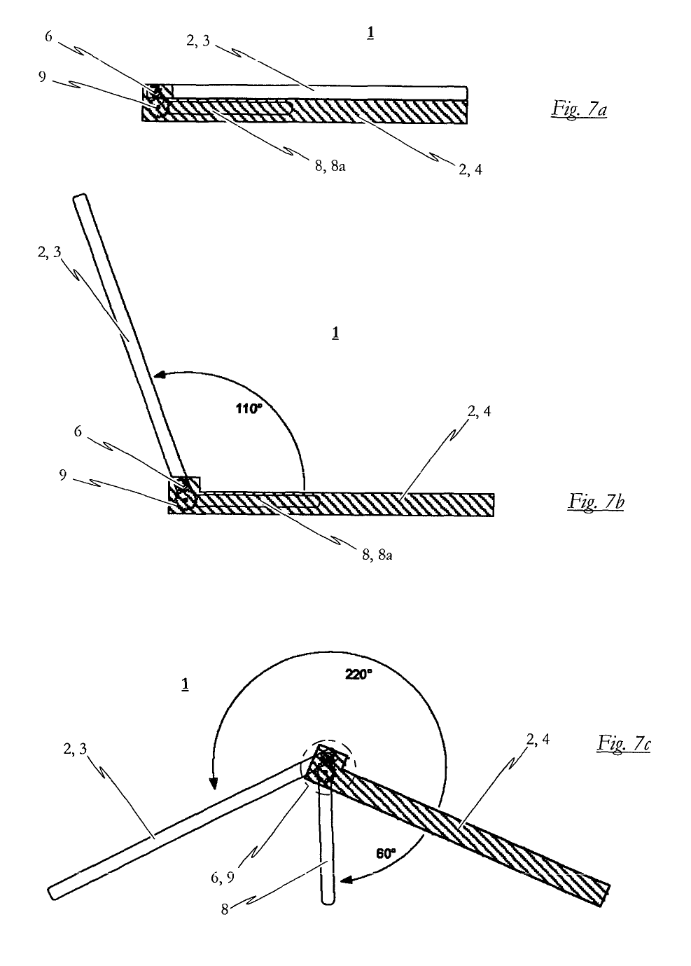

FIG. 2 is a side view of the presentation module shown in FIG. 1;

FIG. 3 is a side view of the presentation module shown in FIG. 1, but this time in a completely opened-out state;

FIG. 4 is a top view of the presentation module shown in FIG. 3, in a completely opened-out state;

FIG. 5 is a top view of a second preferred embodiment of a presentation module according to the invention, in a completely opened-out state;

FIG. 6 is a top view of the rear face of the presentation module shown in FIG. 5;

FIGS. 7a-c are side views, in diagrammatic form, of the presentation module according to the second preferred embodiment for explaining the functioning of the tilting mechanism used therein; and

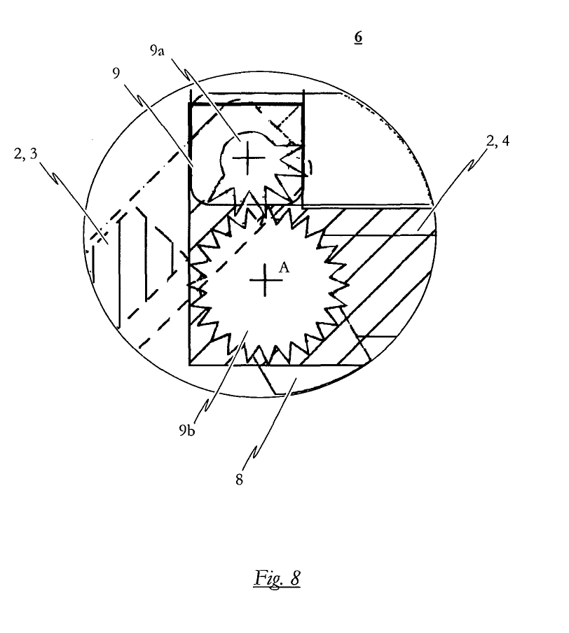

FIG. 8 is a view, in diagrammatic form, for explaining the gear mechanism used in the second preferred embodiment of the presentation module according to the invention.

A first preferred embodiment of the presentation module 1 according to the invention is described hereinbelow with reference to FIGS. 1 to 4. As can be seen especially from FIG. 1, the presentation module 1 has a case-like housing 2 having a first and a second housing shell 3, 4. The two housing shells 3, 4 are connected so as to be tiltable relative to one another by means of a hinge 6. As a result it is possible to open out the housing 2 of the presentation module 1 to a varying extent.

For example, FIG. 2 shows a state wherein the presentation module 1 is in a half opened-out state. The two housing shells 3, 4 therein are tilted through about 90° relative to one another. In the half opened-out state of the housing 2, which state is shown in FIG. 1 or FIG. 2, a locking arrangement 7 is provided by means of which the two housing shells 3, 4 are held relative to one another.

FIG. 3 shows the presentation module 1 with its housing 2 in a completely opened-out state. From this illustration it can be seen that, preferably, the two housing shells 3, 4 of the housing 2 can be tilted through more than 180° (in this case approximately 190° to) 200° relative to one another. It is thereby possible to ensure that the first housing shell 3 is inclined slightly in the direction of the customer (not shown).

From FIG. 1 it can furthermore be seen that a first screen 10 is integrated in the first housing shell 3. In this arrangement, the first screen 10, which serves to show a presentation intended for the customer during the sales discussion, is of a size matched to the size of the installation space maximally made available by the first housing shell 3. Because, as indicated hereinbefore with reference to FIG. 3, the first housing shell 3 is inclined slightly towards the customer when the housing 2 is in the completely opened-out state, the customer can follow, in pleasant manner, the sales presentation shown on the first screen 10 of the presentation module 1.

Preferably, the first screen 10 of the presentation module 1 should have an angle-of-view dependency which is as low as possible, in order to ensure that the customer is always provided with an optimum image on the first screen 10 from different viewing angles.

In addition to the first screen 10, the shown preferred embodiment of the presentation module 1 further has a second screen 20, which serves for showing information intended for the salesperson, especially customer-specific data, and data for controlling the course of the presentation shown on the first screen 10. Compared to the first screen 10, the second screen 20 is substantially smaller because its function is not primarily that of presentation but rather it serves for controlling the course of the presentation shown on the first screen 10.

In a preferred arrangement of the presentation module 1 according to the invention, at least the second screen 20 is in the form of a touch screen monitor so that it is possible, by means of touch screen fields, to input commands and data into the presentation module 1, especially for controlling the course of the presentation shown on the first screen 10. Accordingly, in the presentation module 1 shown, the touch screen fields of the second screen 20 serve as the inputting interface 22 of the presentation module 1.

In addition to this inputting interface 22, it is furthermore feasible for the presentation module 1 to have an additional keyboard (keyboard 23—cf. FIG. 5) connectible to the presentation module 1.

As indicated in diagrammatic manner in FIG. 4, a control system and the already discussed inputting interface 22 are, in addition to the second screen 20, integrated in the second housing shell 4 of the housing 2 of case-like construction. The control system therein serves to appropriately control at least the first screen 10 in dependence on commands and/or data input into the presentation module 1, for example by way of the inputting interface 22. Preferably, control of the second screen 20 is likewise carried out by means of this control system.

Although it cannot be seen explicitly from the drawings shown, the control system further includes, preferably, a storage means for storing presentations which are to be displayed on the first screen 10 and data which is or has been input into the presentation module 1 by way of the inputting interface 22. In addition thereto, preference is given to the control system further having a processor in order to process the data input by way of the inputting interface 22 and in order to modify the presentation to be shown on the first screen 10 in dependence on, for example, data or commands input by way of the inputting interface 22, preferably during the sales discussion.

The control system should further have a preferably wireless communications interface such as, for example, a mobile telephone interface, IR interface or Bluetooth interface in order to make data communications possible with external devices.

As can be seen especially from FIG. 4, a plurality of storage compartments 4 are integrated in the second housing shell 4 of the housing 2 of case-like construction. These storage compartments 5 can perform various functions. Accordingly it is feasible, for example, to provide storage compartments for accommodating business cards, these business cards being inserted vertically into the storage compartments. On the other hand—and this is especially advantageous having regard to a sales discussion—a notepad, for example, should be provided in one of the storage compartments 5, in order to make it possible for the salesperson to make handwritten notes during the sales discussion. Further thereto, it would be feasible for one of the storage compartments to contain the mobile telephone of the salesperson, possibly a portable navigation system or the optionally provided (external) keyboard. It can thereby be ensured that the presentation module 1 contains all the devices and means needed by the salesperson for the sales discussion. Accordingly, the presentation module 1 according to the invention represents a compact and complete solution by means of which sales discussions can be held in especially efficient manner.

FIG. 5 shows, in a top view, a presentation module 1 according to a second embodiment of the present invention, the presentation module 1 of this embodiment being in the completely opened-out state. The presentation module 1 according to the second embodiment differs from the above-described presentation module according to the first embodiment especially in the fact that, in the second embodiment, the second screen 20 and the inputting interface 22 are in the form of a structural unit wirelessly connected to the control system 21, which structural unit can be removed from the second housing shell 4 in order to control the presentation module 1 in especially flexible manner. Preferably, in that arrangement, the inputting interface 22 and the second screen 20 are in the form of a touch screen.

FIG. 6 shows a top view of the rear face of the presentation module 1 according to the second embodiment shown in FIG. 5. From this FIG. 6 it can be seen especially that the presentation module 1 according to the second embodiment has a total of two supports 8, which are in pivotable articulated connection with the second housing shell 4 in the vicinity of the articulated connection, or hinge 6, between the first and the second housing shells 3, 4. In particular, FIG. 6 shows a state where the two supports 8 are in their completely pivoted-in state. In this completely pivoted-in state, the two supports 8 are each accommodated in a recess 8a provided in the second housing shell 4 so that the outer contour of the second housing shell 4 is unchanged.

FIG. 7a to FIG. 7c show, in diagrammatic form, the pivoting out of the two supports 8 in the case of the presentation module 1 according to the second embodiment. In particular, it can be seen from FIGS. 7a to 7c that, up to a particular (predeterminable) degree of relative tilting of the two housing shells 3, 4 in relation to one another, the supports 8 are in their pivoted-in state shown in FIGS. 7a and 7b. Only after a predeterminable angle of tilt has been exceeded, which is preferably greater than or equal to 180°, a gear mechanism 9 to be described in greater detail with reference to FIG. 9 comes into operation, by means of which the supports 8 are pivoted out from the second housing shell 4. As can be seen from FIG. 7c, the supports 8 are suitable for the purpose of holding the presentation module 1 stable in its completely opened-out state, with especially the angle between the two housing shells 3, 4 being reliably maintained. In the mode shown in FIG. 7c, the first screen 10 integrated in the first housing shell 3 has an ideal position relative to the viewer (potential customer), whereas at the same the second screen 20 integrated in the second housing shell 4 also has a suitable position relative to the second viewer (salesperson).

The special gear mechanism 9 used in the case of the second embodiment of the presentation module 1 for deploying the supports 8 will be described in greater detail hereinbelow with reference to FIG. 9. As shown in FIG. 9, the gear mechanism 9 is composed of a first toothed wheel 9a and a second toothed wheel 9b. In this arrangement, the first toothed wheel 9a of the gear mechanism 9 so co-operates with the articulated connection, or hinge 6, that when the two housing shells 3, 4 are tilted relative to one another the first toothed wheel 9a is concomitantly turned. On the other hand, the second toothed wheel 9b of the gear mechanism 9 is associated with the second housing shell 4 and is connected to the pivot shaft A of the support 8. The pivoting-out of the support 8 with the aid of the gear mechanism 9 shown in FIG. 9 is possible because the teeth of the first toothed wheel 9a come to mesh with the teeth of the second toothed wheel 9b only from a predeterminable angle of pivoting set between the first and the second housing shells 3, 4 so that the support 8 begins to be pivoted out from the second housing shell 4 only from the predeterminable angle of pivoting. As shown, this is accomplished by the first toothed wheel 9a having a region without teeth on its periphery.

In the case of the gear mechanism 9 shown in diagrammatic form in FIG. 9, a special toothed wheel mechanism accordingly comes into effect, with the aid of which the support 8 is rotated out from the second housing shell 4. In particular, in the shown preferred embodiment of the presentation display, the support 8 remains sunk into the recess 8a formed in the second housing shell 4 up to an angle of opening of 100°. When this angle is exceeded, the support 8 slowly rotates out from the second housing shell 4 until it then reaches its final position at about 60° and at an angle of housing shell opening of 220°. In this arrangement, as a result of suitable selection of the size of the two toothed wheels 9a, 9b used, a transmission ratio to the first housing shell 3 of 1:1.83 is used.

There will hereinafter be described in greater detail the use of the presentation module 1 according to the invention. In this example, a service provider is making a sales proposal to a customer for the layout and arrangement of advertisements in printed media. This example serves only to illustrate the presentation module 1 according to the invention and should in no respect be regarded as limiting. Of course, the presentation module 1 is suitable for making sales proposals for not only services but also goods.

In particular, a possible use of the presentation module 1 according to the invention is described for the purpose of illustration. In this case, it is assumed that there is a discussion between a salesperson of an advertisement publisher (e.g. a telephone directory publisher or newspaper publisher) and his (potential) customer, with the salesperson making a proposal for an advertisement location and arrangement of a new advertisement or a revision of an existing advertisement. The salesperson is visiting the customer in order to show him a presentation of the possible advertisement, for example in the next edition of the telephone directory.

The presentation module 1 according to the invention is—as already indicated—in such a form that the salesperson requires no further documentation or aids for the sales discussion. In particular, the presentation module 1 is so arranged that particular information and data are displayed on the one hand on the first screen 10 and on the other hand on the second screen 20, preferably in various information fields. This information is, in part, customer-specific information and/or data or also may be information relating to the salesperson (service-provider).

In particular, it is feasible that, at least at the beginning of the sales discussion, general information of the service-provider is presented to the potential customer on the first screen 10 of the presentation module 1. At the same time—preferably also at least at the beginning of the sales discussion—information relating to the customer is displayed to the service-provider (salesperson) on the second screen 20. For example, it would be feasible for there to be shown on the second screen 20 a location plan, for example where the company headquarters of the customer is located, and also other customer-specific data and statistics.

In addition thereto, at least one information field displayed on the second screen 20 should be so arranged that new or updated customer-specific data can be input into this information field by the salesperson by way of the inputting interface (touch screen field 22) during the sales discussion.

Whilst only information which may be of interest to the salesperson during the sales discussion is primarily shown on the second screen 20, the image on the first screen 10 of the presentation module 1 serves to allow a sales presentation to be played by means of which the customer is guided through the proposal of the service-provider and possible customer-specific proposals are submitted. The image on the first screen 10 can of course also be used for discussion relating to existing programs, payment arrangements, customer feedback and for presentation of further advertisement sizes and for selling additional advertisements in other, related sections.

After talking through the customer profile etc., the actual sales discussion begins. For this it is feasible that, for example, the so-called “status quo” state is initially displayed on the first screen 10 of the presentation module 1 and presented to the potential customer. In the present case, therefore, it may be, for example, the extract from a telephone directory in which the customer currently has an advertisement running.

The “status quo” state is then either faded out again or moved into the background of the presentation shown on the first screen 10 so that a revised version of the status quo state shown can be displayed and presented to the potential customer. In the revised version of the status quo state shown there will have been incorporated especially the new concepts of the service-provider, on the one hand, and the updated customer data, on the other hand. Accordingly, in the present specific example, it would be feasible, for example, for there to be shown on the first screen 10 a correspondingly revised page of the telephone directory in which a proposal for an improved and revised layout of the advertisement of the customer has already been incorporated with the aid of the presentation software running, preferably in the background, on the presentation module 1.

In addition it is preferred if information relating to the salesperson or service-provider is displayed to the customer by way of the first screen 10 of the presentation module 1, by means of which the customer quickly obtains an overview of the strategy and success of the service being offered. In the present case it is accordingly feasible for statistical data etc. to be displayed here by means of which it can be seen how the public being addressed will respond to a simultaneously shown revision of the advertisement of the customer.

Because of the size of the first screen 10 it is feasible, for example, for the customer to be presented simultaneously with, on the one hand, the status quo state of, for example, the telephone directory entry or the advertisement of the customer in a telephone directory and, on the other hand, a proposal by the salesperson in which the advertisement of the customer has been correspondingly revised. By means of this presentation and by means of the direct comparison between the status quo state and a possible proposed revision, the customer can immediately recognise the impact and the advantage of accepting the service being offered by the salesperson or of the revision of his advertisement.

The customer now has the possibility of considering his previous advertisement program in the present publication and of comparing it with a proposed, newly arranged advertisement which is graphically enhanced by means of size and colour and also, potentially, positioning on the page. This new advertisement, which represents the basis for the proposal, is paginated completely anew with the exact competition data of the previous year.

The presentation module described is not limited just to the selling of advertisements in trade telephone directories etc. It can also be used in sales discussions in many other lines of business. The financial services and insurance industries should be mentioned primarily. In principle, the presentation module can be used wherever a customer requires a more or less individual consultation with a salesperson for tailoring an individual proposal. This may also be, for example, in the capital goods industry.

### List of Reference Numerals

1 presentation module

2 housing

3, 4 housing shell

5 storage compartment

6 hinge

7 locking arrangement

8 support

8a recess

9 gear mechanism

9a first toothed wheel

9b second toothed wheel

10 first screen

20 second screen

22 inputting interface

23 keyboard

A pivot shaft of support

What is claimed is:

1. Presentation module, especially for use as an electronic selling aid for advertisements, for example in print media, or for insurance policies, the presentation module (1) having the following:
a first screen (10) for showing a presentation intended for a customer; and
a control system (21) for controlling the first screen (10) in dependence on commands and/or data input into the presentation module (1),
characterised in that
the control system (21) has the following:
a second screen (20) for showing information intended for a salesperson, especially for showing customer-specific data, and for showing data for controlling the course of the presentation shown on the first screen (10); and
an inputting interface (22) for inputting commands and/or data in dependence on the information shown on the second screen (20);
the presentation module (1) further having a housing (2), and especially a case-like housing (2), having a first and a second housing shell (3, 4) connected in articulated manner with one another by way of a connection (6), and the first screen (10) being integrated in the first housing shell (3) and the second screen (20) together with the inputting interface (22) being integrated in the second housing shell (4).

2. Presentation module according to claim 1, wherein, for opening out the housing (2), the two housing shells (3, 4) are tiltable relative to one another, preferably up to 220°, the control system (21) being arranged to adjust the orientation of the presentation shown on the first screen (10) in dependence on the degree of opening-out of the housing (2).

3. Presentation module according to claim 2, wherein, when the housing (2) is in the completely or almost completely opened-out state, the presentation shown on the first screen (10) is oriented in a direction opposite to the orientation of the information and data shown on the second screen (20), and wherein, when the housing (2) is in a state opened out by about 100° to 110°, the presentation shown on the first screen (10) is oriented in the same direction as the information and data shown on the second screen (20).

4. Presentation module according to claim 1, wherein the presentation module (1) further has a locking arrangement (7) for locking the first and second housing shells (3, 4) relative to one another at a preferably freely selectable angle of tilt.

5. Presentation module according to claim 1, wherein the presentation module (1) further has a support (8) which is in pivotable articulated connection with the second housing shell (4) at or in the vicinity of the articulated connection (6) between the first and the second housing shells (3, 4).

6. Presentation module according to claim 5, wherein the support (8), in its pivoted-in state, is accommodated in a recess (8a) provided in the second housing shell (4).

7. Presentation module according to claim 6, wherein at the articulated connection (6) between the first and the second housing shells (3, 4) there is provided a gear mechanism (9) having a first toothed wheel (9a) and a second toothed wheel (9b), the first toothed wheel (9a) so co-operating with the articulated connection (6) that when the two housing shells (3, 4) are tilted relative to one another the first toothed wheel (9a) is concomitantly turned, and wherein the second toothed wheel (9b) is connected to a pivot shaft (A) of the support (8), and wherein the teeth of the first toothed wheel (9a) are arranged to come to mesh with the teeth of the second toothed wheel (9b) only from a predeterminable angle of pivoting set between the first and the second housing shells (3, 4) so that the support (8) begins to be pivoted out only from the predeterminable angle of pivoting.

8. Presentation module according to claim 7, wherein the first toothed wheel (9a) and/or the second toothed wheel (9b) has a region without teeth on its periphery.

9. Presentation module according to claim 1, wherein the second screen (20) and the inputting interface (22) are in the form of a structural unit connected, preferably wirelessly, to the control system (21), which structural unit can be removed from the second housing shell (4).

10. Presentation module according to claim 1, wherein the control system (21) further has the following:
a storage means for storing presentations and data input by way of the inputting interface (22); and
a processor for processing data input by way of the inputting interface (22) and for modifying the presentation to be shown on the first screen (10) in dependence on data or commands input by way of the inputting interface (22).

11. Presentation module according to claim 1, wherein the control system (21) further has, for data communications with external devices, a wireless communications interface, especially a mobile telephone interface, IR interface or Bluetooth interface.

12. Presentation module according to claim 1, wherein the outer edges of the housing (2) have a rounded-off shape such that that surface (A) of the housing on which the housing (2) lies is defined by the outside of the first or the second housing shell (3, 4).

13. Presentation module according to claim 1, wherein at least the second screen (20) is in the form of a touch screen, and wherein the inputting interface (22) is integrated in the second screen (20) in the form of a touch screen.

14. Presentation module according to claim 1, wherein the inputting interface (22) has a keyboard (23) connected or connectible to the control system (21).

15. Presentation module according to claim 1, wherein at least the first screen (10) is in the form of a display screen without a particular preferential viewing direction.

16. Presentation module according to claim 1, which further has an internal power supply in the form of preferably rechargeable batteries and/or a fuel cell.

17. Presentation module according to claim 1, wherein the first screen (10) is of a size matched to the size of the installation space maximally made available by the first housing shell (3), and wherein at least one storage compartment (5) accessible in the open state of the housing (2) is, in addition to the second screen (20), integrated in the second housing shell (4).

18. Presentation module according to claim 1, which further has a protective covering mounted on the first housing shell (3), the protective covering being movable in front of the first screen (10) or in front of the rear face of the first housing shell (3) as required.

19. Presentation module according to claim 5, wherein at the articulated connection (6) between the first and the second housing shells (3, 4) there is provided a gear mechanism (9) having a first toothed wheel (9a) and a second toothed wheel (9b), the first toothed wheel (9a) so co-operating with the articulated connection (6) that when the two housing shells (3, 4) are tilted relative to one another the first toothed wheel (9a) is concomitantly turned, and wherein the second toothed wheel (9b) is connected to a pivot shaft (A) of the support (8), and wherein the teeth of the first toothed wheel (9a) are arranged to come to mesh with the teeth of the second toothed wheel (9b) only from a predeterminable angle of pivoting set between the first and the second housing shells (3, 4) so that the support (8) begins to be pivoted out only from the predeterminable angle of pivoting.

20. Presentation module according to claim 19, wherein the first toothed wheel (9a) and/or the second toothed wheel (9b) has a region without teeth on its periphery.
